(19) United States
(12) Patent Application Publication
(10) Pub. No.: US 2009/0165644 A1
(43) Pub. Date: Jul. 2, 2009

(54) Air Filter Apparatus with Self-Contained Detachable Programmable Clogging Indicator

(76) Inventor: David F. Campbell, St. Augustine, FL (US)

Correspondence Address: MATTHEW P. DAVIES - 07001-1, 13870 Devan Lee Drive North, JACKSONVILLE, FL, 32226, US

(21) Appl. No.: 12/340,997

(22) Filed: Dec. 22, 2008

Related U.S. Application Data
(60) Provisional application No. 61/017,826, filed on Dec. 31, 2007.

(51) Int. Cl. B01D 46/42

(52) U.S. Cl. 95/25; 96/422; 96/419

(57) ABSTRACT

An air filter apparatus with a self-contained detachable programmable clogging indicator for use in forced air HVAC systems, air heaters, internal combustion engines, vacuum cleaners, medical devices, biomedical devices, inert atmosphere glove boxes, scientific equipment, etc. . . . and method of use is disclosed. The self contained detachable clogging indicator consists of downstream rotating vane anemometer to measure the air flowing through the filter as a means to accurately estimate the degree of filter clogging. A detachable user interface allows manipulation of the operating parameters and threshold limits and provides a means to alert the user of filter replacement. The filter media is inserted into the filter housing and may be a specialty or commercially available filter.

### CROSS REFERENCE TO RELATED APPLICATIONS

The present application claims the benefit of the Provisional Application No. 61/017,826 filed Dec. 31, 2007.

### STATEMENT REGARDING FEDERALLY SPONSORED RESEARCH OR DEVELOPMENT

Not Applicable

### BACKGROUND OF THE INVENTION

1) Field of the Invention

This invention relates generally to an air filter apparatus with a self contained detachable programmable clogging indicator for use in forced air heating and cooling systems

2) Discussion

Air filters have long been used in forced air heating and cooling systems to purify air by removing particulate matter of varying size. Conventional Heating, Ventilation and Air Conditioning (HVAC) systems recycle the room air by forcing it through a filter and redirecting it to various locations within the same or multiple rooms. As the air filter traps particulate matter of varying size the air flowing per unit volume through the filter decreases, reducing the ability of the filter to remove heavier, larger size particles. This also reduces the efficiency of the forced air heating and cooling system as the constant pulling of air on the downstream side forces the air to bypass the clogged filter and enter the system through any available space. Additionally reducing the efficiency of the forced air system increases the load on the system to continue to move the same volume of air.

One solution is to use sensors to detect and indicate the degree of filter clogging so as to alert the user of the appropriate time to change the filter. Several devices have been created and incorporated into the filtering system to accomplish such goals.

Typical air filter clogging indicators employ various sensing devices intended to detect the useable life of an HVAC air filter. These detecting means include pressure, flow, and thermal differential, laser, sonic wave measurement, and a simple non-sensing countdown timer.

In general, several drawbacks exist with these types of sensors. Namely they tend to get clogged by debris, require modification to the HVAC system, consume large amounts of electricity, are effective only at small volume-high velocity, and/or are inadequate at predicting useful filter life. First, the aforementioned devices measuring pressure, thermal, and flow differential generally suffer from clogging and require modification of the HVAC system both upstream and downstream of the filter which can be complicated, time consuming and expensive. Most Thermal differential devices require small volumes of air to accurately sense a temperature drop between the heat emitting element and air flow measuring sensors. Still other flow differential devices insert directly into the filter itself and suffer from clogging in addition to a decrease in the effective filter surface area. Second, those devices that measure air flow through the use of a laser or sonic wave also require HVAC modification, small air flow volumes and additionally consume relatively large amounts of electricity. Lastly those devices which simply countdown the time elapsed between filter changes rely on a series of ideal use parameters to estimate the next filter change. These ideal parameters include but are not limited to an efficient and clean HVAC system, constant use, light to moderate amounts of particulate matter, constant temperature of use, etc. . . .

Due to the unpredictable nature of particulate size, makeup, temperature changes, geometry of the dwelling, and condition of HVAC, a more accurate estimate of the useable life of the filter is paramount. This gives rise to the need for a self contained detachable clogging indicator that is efficient and inexpensive to indicate replacement. Therefore it is the object of this invention to solve one or more of these problems.

### SUMMARY OF THE INVENTION

In accordance with the teachings of this invention as embodied and described herein, an air filter apparatus with a self-contained detachable programmable clogging indicator for use in forced air HVAC systems, air heaters, internal combustion engines, vacuum cleaners, medical devices, biomedical devices, inert atmosphere glove boxes, scientific equipment, etc. . . . and method of use is disclosed.

One embodiment of the apparatus consists of a standard type HVAC filter contained within a filter housing which incorporates a detachable sensor for measuring the degree of clogging via a constant voltage output from a downstream rotating vane anemometer. The detachable sensor may be placed at a location in the HVAC system downstream of the filter by mechanical clips or magnets. Said sensor in connected to the filter housing via an electrical wire to allow electricity to pass from the sensor to the user interface. As air flows unobstructed through the clean filter, the anemometer generates a constant output voltage when the HVAC system is in use. The anemometer is further connected to an electrical circuit capable of processing algorithms used to detect the operational status of the HVAC system, recharge the power cells, accept user programming, and alert the user to the degree of filter clogging. The user may program the apparatus based on their unique HVAC requirements. When the degree of clogging approaches an unacceptable threshold level the user is alerted by the user interface through either an audio or visual alarm, or a combination thereof.

A further embodiment of the invention is to provide an apparatus free from flow obstruction, clogging, or the need for HVAC modification, and is of an efficient, reliable, low cost design requiring minimal time, effort, and skill to install and use.

In selected embodiments the degree of clogging may be chosen either by manipulation of the user interface, or by a more specialized filter type including but not limited to HEPA, foam, pleated paper, cotton, spun fiberglass, synthetic, electrostatic, polymeric and zeolite based.

Embodiments in accordance with this invention may be particularly advantageous when it is desirable to preserve the ability to effectively and efficiently remove particulate matter using an HVAC system.

### BRIEF DESCRIPTION OF DRAWINGS

FIG. 1 is a perspective view of the filter apparatus showing the detachable sensor and user interface location.

FIG. 2 is a perspective view of an enlarged section of the filter assembly.

FIG. 3 is a side view of the filter apparatus showing depth of placement of sensor and user interface with in the filer housing when they are attached to said housing assembly.

FIG. 4 is a perspective view of the user interface assembly.

FIG. 5 is an exploded perspective view of the anemometer.

FIG. 6 is a bock diagram of the circuitry employed in the system of the present invention.

### DETAILED DESCRIPTION OF THE INVENTION

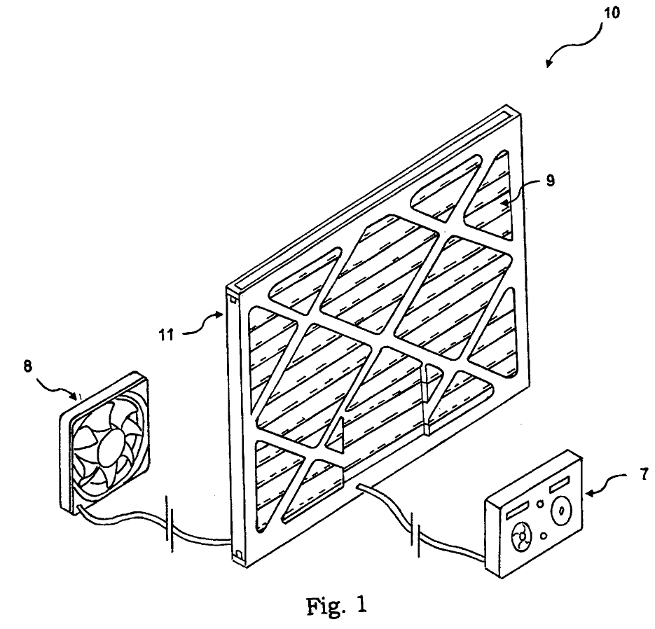

Referring now to the drawings, and more particularly FIG. 1, the present invention includes an air filter apparatus with a self-contained detachable programmable clogging indicator 10. The apparatus 10 includes an air filter 9, rotating vane anemometer 8, user interface 7, and filter apparatus housing 11, and may be of any size, shape or color. In addition the apparatus 10 may be constructed, assembled, formed, machined, extruded, molded, cast, or otherwise made from any suitable material as discussed individually below.

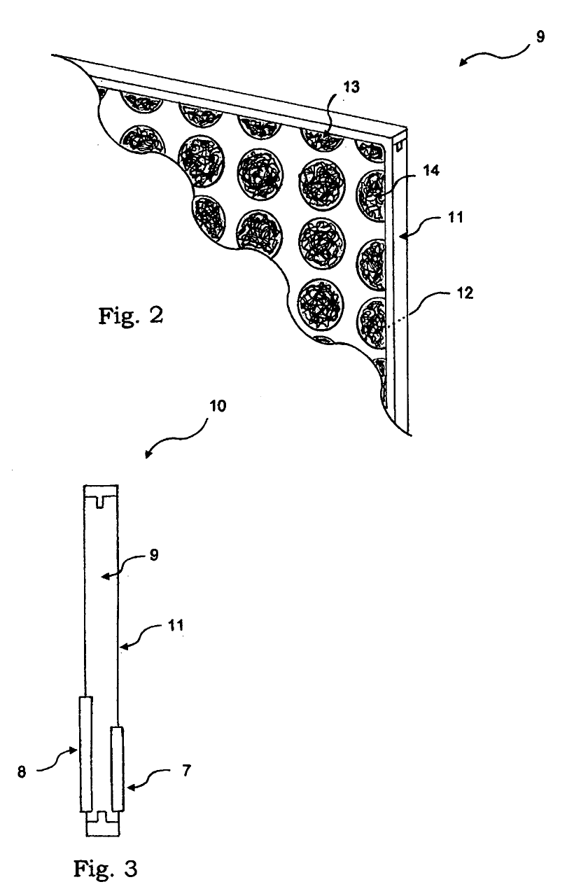

As shown if FIG. 2 an filter 9 consists of filter media 14 and a filter housing frame 11 to which the filter media 14 is inserted. The filter assembly 9 may be constructed, assembled, formed, machined, extruded, molded, cast or otherwise made of any suitable material and may be molded or otherwise constructed in its original forming process to receive the anemometer 8, and user interface 7, as shown in FIG. 3. Anemometer 8 and user interface 7 may be attached to filter housing 11 for storage and detached from said filter housing 11 when assembly 9 is in use. Additionally the aforementioned anemometer 8 and user interface 7 may be attached through the use of mechanical clips, screws, or the like.

As shown in detail in FIG. 2 the filter media 14 having an upstream surface 12 and a downstream surface 13, maybe constructed, formed, machined, woven, blown, punched or otherwise constructed in any shape, size, or color, and of any suitable material. The suitable material of filter media 14 may include without limitation pleated paper, cotton, foam, spun fiberglass, HEPA (type material), synthetic, electrostatic, polymeric, zeolite, or any variation or combination thereof.

For the purposes of this invention the filter apparatus 9 is to be generally used in air, but it is to be understood that the present invention is equally applicable for use with any gaseous stream containing particulate matter including but not limited to Nitrogen, Argon, Hydrogen, or Helium.

The housing frame assembly 11 may be constructed, pressed, assembled, formed, machined, extruded, molded, cast or otherwise made of any suitable material including but not limited to cardboard, bio-degradable compounds, plastic, metal, fiberglass, composite, or the like. The housing frame assembly 11 may be of any size, shape, color, or dimensions. Generally the filter media 14 is inserted into the filter housing 11 and secured in place by attaching means. Whereas the attaching means may include without limitation adhesive, adhesive tape, cross member support structure, guide rails, mechanical clips, bolts, screws, or the like.

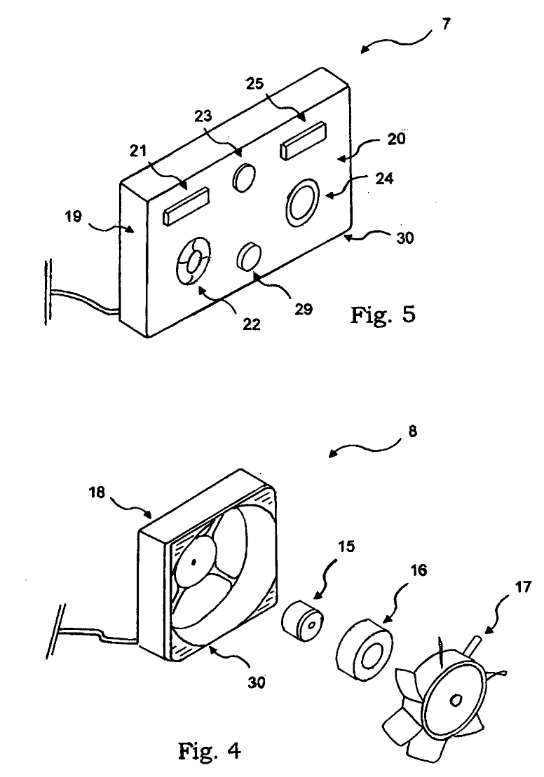

Referring now to FIG. 4, an electricity generating rotating vane anemometer 8 as shown may be directly or indirectly attached to user interface 7. The anemometer 8 consists of an electricity generating motor 15 attached to a rotor 16, mounted to spin around the motor axis. Said rotor is attached to a plurality of orthogonally disposed vanes 17, whereas the motor, rotor, and vane assembly are supported and housed in the anemometer frame 18. The anemometer assembly 8 may be constructed, assembled, formed, machined, extruded, molded, cast, or otherwise made of any suitable material including without limitation plastic, metal, fiberglass, ceramic, composite, bio-degradable compounds, or the like. In addition, anemometer 8 may be of any size, shape, dimension, or color, and may be located at any point in the HVAC system downstream of the filter apparatus 10. Anemometer 8 is in constant electrical communication with user interface 7 through an electrical wire, which may be of any size, gauge, or length. Said wire is attached to both anemometer 8 and user interface 7 and is fastened to the filter housing 11. When anemometer 8 is in use and detached from filter housing 11 it is attached to the HVAC system at a point downstream through the use of adhesive, adhesive tape, mechanical clips, or a magnetic strip 30 as shown in FIGS. 4-5. The stored anemometer 8 and user interface 7 assembly of FIGS. 4-5 may also be attached to a cross-member support structure of the filter media 14 and filter housing 11 through the use of mechanical clips, screws, or the like.

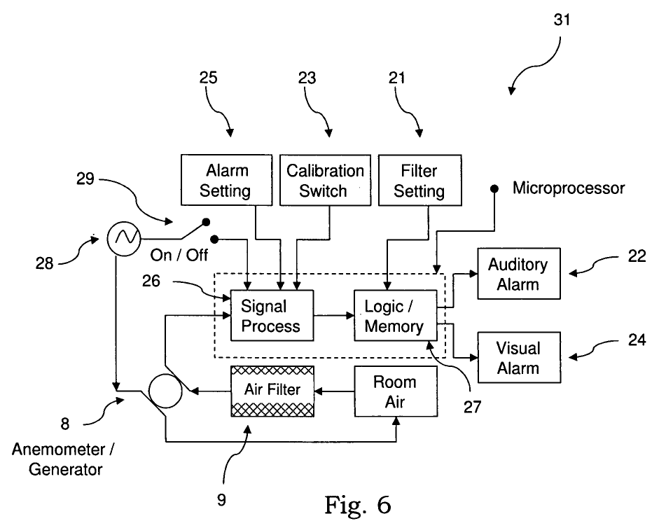

The user interface 7 of FIG. 5 consists of a user interface frame 19 housing the electronic circuitry 31 (FIG. 6) and front face plate 20. In an alternative embodiment user interface 7 may include an electronic plug to supply power to the interface circuitry 31. The front face plate 20 of user interface 7 includes an audible alarm 22, a visual alarm 24, and a plurality of manually adjustable switches including a calibration setting 23, filter setting 21, and alarm setting 25. Said switches may be chosen from a plethora of switch types including but not limited to membrane, toggle, rocker, push-button, DIP, or the like. The user selectable switches thereby specify the operating parameters, calibrated alarm thresholds, programmed actuation limits of the HVAC system, and allow the accurate estimation of the degree of filter clogging.

In accordance with the present invention, FIG. 6 shows a block diagram of a preferred embodiment of the user interface circuitry 31 which is mounted within housing 19. Operation of the user interface 7 is controlled by the interface circuitry 31. Microprocessor means are used to interpret anemometer 8 output signals, calculate threshold values, store threshold values, activate indicators, and calibrate the apparatus. The interface circuitry 31 consists of a power supply 28, microprocessor, calibration switch 23, alarm setting switch 25, filter setting switch 21, auditory 22, and visual 24 indicators. The power supply 28 is sufficient to power the interface circuitry 31 and may include a battery or an electrical plug. In the case of a battery, the power supply 28 may be rechargeable. Additionally, the microprocessor may contain a signal processor 26, and logic/memory 27 components. The interface circuitry 31 (which may be analog, digital, or both) is connected to the anemometer 8 via an electrical wire, allowing the signal processor 26 to sample the output voltage.

As air flows unobstructed through the clean filter 9, the anemometer 8 spins and may generate an electrical output in the form of a voltage, current, or wattage or any combination thereof. This gives an output voltage proportional to the air flowing through the filter. The apparatus may be calibrated via the calibration switch 23 which causes the signal processor 26 to sample the output voltage from the anemometer 8. The sample voltage is then set as the upper limit value by the logic circuit 27 and stored in RAM memory.

As the filter 9 accumulates particulate matter, air flow through the filter 9 steadily decreases. As the anemometer's 8 output voltage changes, its value is continuously checked and compared by the logic circuit 27 to the upper limit value stored in memory. The logic circuit 27 then registers a constant, slow decrease in the sampled output voltage. On board software is employed to extrapolate a threshold value based on the user setting, filter setting, calibrated upper limit value, and a zero anemometer 8 output voltage corresponding to HVAC inactivity. When the sampled output voltage from the anemometer 8 falls below the threshold value, the logic circuit alerts the user through the activation of the user selected auditory 22 and/or visual 24 alarms. The auditory indicator 22 may be of any size, shape or type including but not limited to moving coil type speaker, piezoelectric type speaker, or the like. The visual indicator 24 may be of any size, shape, or type including with out limitation an incandescent light bulb, fluorescent light bulb, LED, OLED, LCD, Display, or the like. User selected alarms 22, and 24, may be silenced by the on/off switch 29 (FIGS. 5 & 6).

Under varying conditions such as cooling and heating (for example summer or winter) the HVAC power requirements change causing an increase or decrease in routine air flow. This is normal of HVAC systems and the software driven logic circuit 27 is set to differentiate between a constant upper limit voltage (consistent with a clean filter), a constantly decreasing voltage (consistent with an increasingly clogged filter), and a sudden decrease in voltage (consistent with air blower actuation or a period of inactivity when the HVAC system is not running).

When the HVAC system is running and anemometer 8 is operating above the threshold value, an electric current is generated and used to charge power supply 28. Additionally by using anemometer 8 as an air flow sensor to determine HVAC inactivity the logic circuit 27 can initiate a “sleep mode” to conserve power while the system is not in use.

To summarize the interface circuitry 31 method and operation, consider the following series of steps by the logic circuit. A new or cleaned air filter is installed into the air duct and the HVAC system is turned “on”.
Input anemometer=IAO
Input calibration button=ICAL
Input diff percentage IDP
Input alarm condition IAC
Output alarm condition=OAC
1. Initial startup
2. Wait until battery monitor reaches preset threshold, and turns on the run light (voltage now high enough to run processor)
3. Wait until IAO is greater than base voltage of motor, states AC system has initiated system calibration.
4. Start 30 second timer and wait for anemometer to reach full RPM
5. Look for ICAL
6. Wait 30 seconds
7. Store ICAL in register memory. This value will stay in memory until the ICAL button is pushed again.
8. Look at IDP switch to find differential percentage (20, 30, 40)
9. Store differential set point DSP value=ICAL−(IDP/ICAL).
10. Look at IAO value and compare to DSP value.
11. If IAO value is significantly different than DSP value (more than 40) then recalculate ICAL to cool setting.
12. If IAO value is significantly different than DSP value (less than 40) then recalculate ICAL to heater setting.
13. If IAO value is less than DSP value, start 60 second timer.
14. Wait 60 seconds.
15. Look at IAO and compare its value to the DSP value
16. If the IAO value is less than the DSP value, call alarm
17. Initiate the flip-flop circuit (which will remain on until the IAO value is less or equal to the DSP value, but greater than zero).
18. The flip-flop circuit then initiates the alarm circuit
19. Determine the OAC value, either visual or audible
20. Initiate the alarm state.
21. Go to line 4

The various embodiments of the present invention as shown in FIGS. 1-6 may be arranged and designed in a wide variety of different configurations that fall within the scope of the present invention, and may be applied to any type of system involving the use of filters including but not limited to household furnaces, automotive power trains, biomedical systems, or the like.

In short, the filter apparatus with self-contained programmable clogging indicator provides a unique design for efficiently and effectively removing particulate matter from an air stream. Regardless of the conditions, whether low pressure or high density filters, or use during the summer or winter months, the combination of the calibration switch and the onboard software will allow the correct detection of filter clogging and alert the user to the need for replacement.

The foregoing discussion discloses and describes merely exemplary embodiments of the present invention. One skilled in the art will readily recognize from such discussion, and from the accompanying drawings and claims, that various changes, modifications, and variations can be made therein without departing from the spirit and scope of the invention as defined in the following claims.

The invention claimed is:

1. An air filtration apparatus with clogging indicator for removal of particulate matter from an air stream comprising:
a filter media;
a filter housing to support said filter media;
a flow rate sensor detachably mounted in connection with said filter housing; and
a user interface detachably mounted in connection with said filter housing.

2. The apparatus of claim 1, wherein said flow rate sensor is located at a position downstream of the filter.

3. The apparatus of claim 2, wherein said flow rate sensor is a rotating vane anemometer.

4. The apparatus of claim 1, wherein said user interface further comprises:
a power supply;
a microprocessor;
a plurality of switches; and
a series of indicators.

5. The apparatus of claim 4, wherein said microprocessor further comprises:
a signal processor to sample said flow rate sensor output value;
a memory function to store sampled/threshold values for recall; and
a logic circuit for generating a threshold value, comparing the air flow sensor value to said threshold value, and initiating indicators when appropriate.

6. The apparatus of claim 4, wherein said plurality of switches includes an on/off switch, calibration switch, filter setting switch, and an alarm setting switch.

7. The apparatus of claim 4, wherein said series of indicators includes a visual and auditory indicator.

8. An air filtration apparatus with clogging indicator for removal of particulate matter from an air stream comprising:
a filter media;
a filter housing to support said filter media;
a flow rate sensor detachably mounted in connection with said filter housing;
a user interface detachably mounted in connection with said filter housing;
a microprocessor means to accurately estimate the degree of filter clogging; and
an indicator means to alert the user to the degree of filter clogging.

9. The apparatus of claim 8, wherein said microprocessor means to accurately estimate the degree of filter clogging is in response to data received from said airflow sensor.

10. The apparatus of claim 7, wherein said microprocessor means to accurately estimate the degree of filter clogging triggers said indicator means upon reaching the threshold value.

11. A method to accurately estimate the degree of filter clogging comprising the steps of:
installing a clean disposable air filter with self-contained detachable clogging indicator into forced air system,
sampling the air flow sensor output value and setting said value as the upper limit value,
calculation of threshold value based on user setting and zero output air flow sensor value corresponding with an inactive state,
continuously monitoring air flow sensor output during normal operation and comparing said value to said threshold value,
activating user selected indicator when said air flow sensor output value equals said threshold value.
